(19) United States
(12) Patent Application Publication
(10) Pub. No.: US 2012/0224739 A1
(43) Pub. Date: Sep. 6, 2012

(54) Cartridge for Managing Ear Bud Cables Having Annular Audio Contacts

(75) Inventors: John Cataldo, Westlake Village, CA (US); Daniel C. Sullivan, Santa Barbara, CA (US); Mardis Bagley, San Francisco, CA (US)

(73) Assignee: HEADLOGIC LLC, Westlake Village, CA (US)

(21) Appl. No.: 13/410,030

(22) Filed: Mar. 1, 2012

Related U.S. Application Data
(60) Provisional application No. 61/447,816, filed on Mar. 1, 2011.

(51) Int. Cl. H04R 1/10

(52) U.S. Cl. 381/384

(57) ABSTRACT

A cartridge usable with a portable electronic device for managing an ear bud cable comprises a housing having a hub, a spool and stationary audio contacts fixed with respect to a hub axis. The stationary audio contacts are annular in shape and insulated from each other and from the housing. The stationary audio contacts are spaced equally from each other, and are each placed at fixed distance from the hub axis. The annular stationary audio contacts connect electrically with an auxiliary audio jack and a contact pad for simultaneously connecting the device to more than one audio device. Conductive contacts are placed on a bottom side of the spool, and are spring loaded to maintain continuous electrical contact with the stationary audio contacts.

### PRIORITY CLAIM

This invention claims priority to U.S. Provisional Patent Application Ser. No. 61/447,816, which was filed 1 Mar. 2011, the disclosure of which is incorporated herein by reference.

### FIELD OF THE INVENTION

The present invention relates in general to a retractable ear bud module for audio devices including portable hand held consumer electronic devices.

### BACKGROUND

Recent research into the effect of cell phone radiation on human health, indicate that the electromagnetic radiation from the cell phone may cause health problems in some users. The risk of health problems due to the absorption of electromagnetic radiation by the human head decreases significantly when cell phones are kept at a distance from the user. Cell phones can be kept away from the ear by using a speaker phone facility provided with the cell phone or by using ear buds and a microphone mounted on a cable.

The health risks associated with cell phone use can be reduced by using a Bluetooth™ headset. The radiation emitted from a cell phone with a Bluetooth headset is less than that emitted during the direct use of the cell phone. But the Bluetooth™ headset may lack sound quality when compared to the sound quality of wired headsets.

The portable hand held consumer electronics market is growing rapidly. The hand-held electronic devices include a large variety of products like cellular phones, tablets, media players, game players etc. Most of these devices include speakers for reproducing digital audio signals. The downside of using speaker is that the audio may distract and annoy anyone around the user. Most of these devices also include a connector for making connections to a headphone. The use of headphones for listening to the audio will prevent other people from hearing the sound. But the tangling of the wires can be one of the most bothersome aspects of headphones.

Headphone cables may become tangled, kinked, or otherwise jumbled, even though the user may have spent time neatly wrapping them around the media player before the device in the user's pocket. An efficient cord management system should prevent the headphone cables from snagging and catching on objects or getting tangled inside the pocket of the user even when the user is not using the product for its specific function. Therefore there is a need for an improved and efficient cord management mechanism to eliminate the hassle of untangling cords to use the headphone.

The ear bud management system should enable the user to simply wrap the headphone cord without tangling and should enable the user to readily extend and retract earphone cables in a rapid and reliable manner. Ear buds are defined as any device carrying a speaker that attaches to the head or ear of a user.

### SUMMARY OF THE INVENTION

The present invention provides a cartridge useful to connect with at least one audio device and provides improved ear bud cable management. The cartridge comprises a housing having a top portion, a bottom portion, a plurality of side walls, a hub fixed on the bottom portion of the housing, a plurality of stationary audio contacts placed around the hub, a power spring operatively connected to the hub, a spool having a top plate and a bottom plate rotatably mounted on the hub, a rotary damper operatively mounted on the bottom portion of the housing, an ear bud cable having a first end and a second end and is wrapped at least partially around the spool, a cable guide which is attached to the bottom portion of the housing and a ratchet mechanism having a ratchet arm, a compression spring and a release button to keep the ear bud cable deployed at any desired length.

The spool rotates store, pull and retract the ear bud cable and reduces the chances of tangling of the ear bud cable. The power spring is used as a tension mechanism for rotating the spool to retract the ear bud cable. At least one among the plurality of side walls of the housing includes an opening through which the ear bud cable may be deployed. At least one of the pluralities of side walls includes the release button for the ratchet mechanism to retain the length of the dispensed ear bud cable.

The plurality of gear teeth on the periphery of the bottom plate of the spool rotatably engages with the plurality of gear teeth of the rotary damper and prevents the misalignment of the spool. The rotary damper regulates the speed of rotation of the spool and prevents the cartridge from getting damaged. The ratchet mechanism prevents the rotation of the spool to retract the ear bud cable. The release button provided on at least one of the plurality of side walls operates the compression spring to push the ratchet arm. The ratchet arm engages with any of the plurality of gear teeth on the periphery of the bottom plate of the spool to block the free rotation.

The first end of the ear bud cable includes a microphone for use with telephonic applications. The ear bud cable is substantially flat and has a height and a width. The width of the ear bud cable is more than the height. The flat shape of the ear bud cable consumes only less space thereby increasing the length of the cable that can be wrapped around the spool. The plurality stationary audio contacts fixed on the bottom portion of the spool are insulated from each other and from the housing and electrically connected to a left speaker, right speaker, ground and a microphone. The spool includes a plurality of conductive contacts on a bottom side of the spool to maintain continuous contact with the plurality of stationary audio contacts. When the spool rotates the plurality of conductive contacts slides over the plurality of stationary audio contacts and thereby continuously providing electrical connection from the audio device to the ear bud cable.

### BRIEF DESCRIPTION OF THE DRAWINGS

FIG. 1 is a perspective view of a cartridge useful to connect with a portable electronic device according to the preferred embodiment of the present invention;

FIG. 2 is a perspective view of a bottom portion of the cartridge with a spool shown in an exploded form according to the preferred embodiment of the present invention;

FIG. 3 is a perspective view of the bottom portion of the cartridge with the spool removed from a hub according to a preferred embodiment of the present invention;

FIG. 4 is a perspective view of a bottom portion of the spool in accordance with the preferred embodiment of the present invention; and

FIG. 5 is a cross-sectional view of the cartridge in accordance with the preferred embodiment of the present invention.

### DETAILED DESCRIPTION

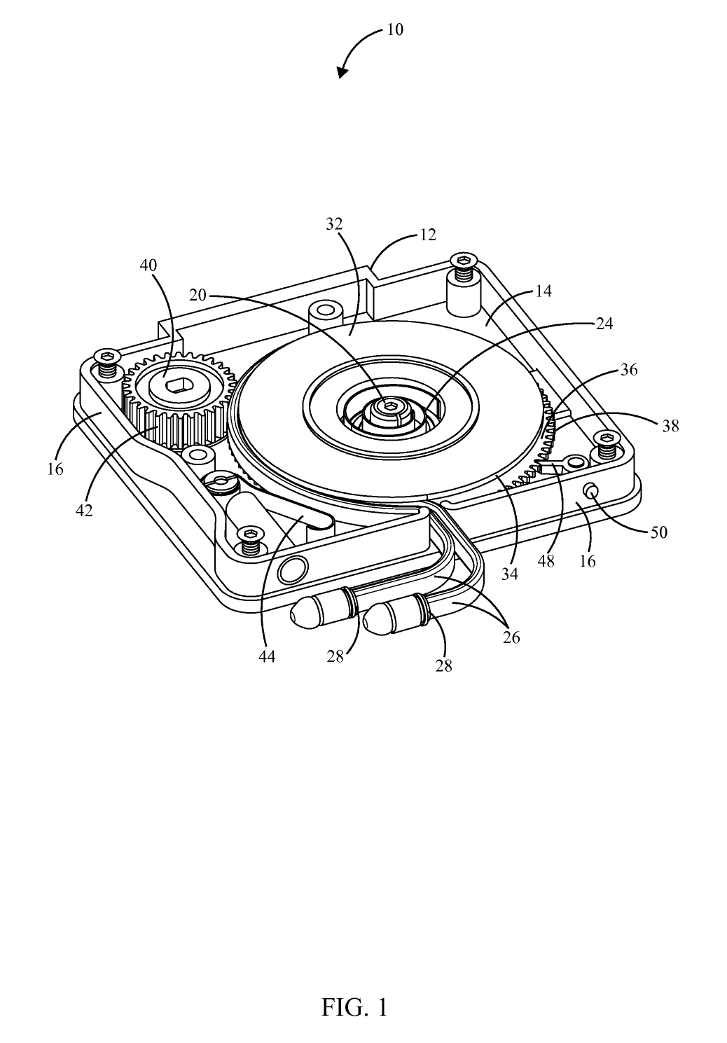

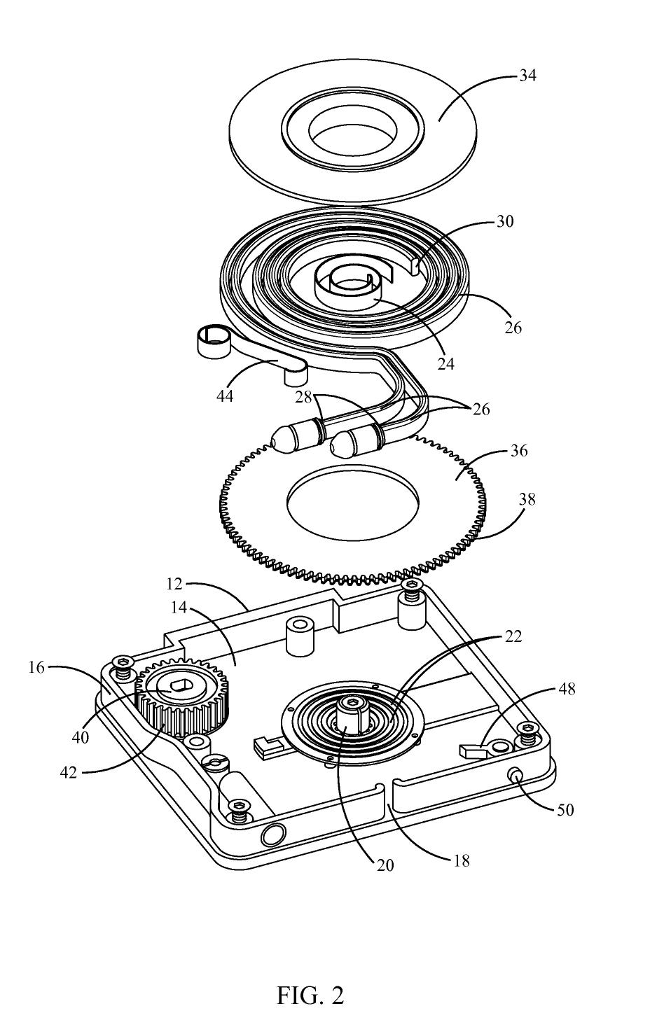

FIG. 1 is a perspective view of a cartridge 10 useful to connect with a portable electronic device, such as an audio device, in accordance with the preferred embodiment of the present invention. The cartridge 10 comprises a housing 12 having a top portion (not shown), a bottom portion 14, a plurality of side walls 16 and a hub 20 fixed on the bottom portion 14 of the housing 12. A plurality of stationary audio contacts 22 (FIG. 2) are placed in an annular pattern around an axis defined by the hub 20. A power spring 24 is operatively connected to the hub 20 for rotation to wind up and dispense an ear bud cable 26.

A spool 32 having a top plate 34 and a bottom plate 36 is rotatably mounted on the hub 20. The cartridge 10 also includes a rotary damper 40 rotatably mounted on the bottom portion 14 of the housing 12. An ear bud cable 26 having a first end 28 and a second end 30 is wrapped at least partially around the spool 32. A cable guide 44 is attached to the bottom portion 14 of the housing 12. A ratchet mechanism having a ratchet arm 48, a compression spring (not shown) and a release button 50 is provided to keep the ear bud cable 26 deployed at any desired length.

The cartridge 10 ensures better cord management system to the ear bud cable 26. The hub 20 fixed on the bottom portion 14 of the housing 12 may have a substantially cylindrical shape. The power spring 24 has a spiral shape and is placed around the hub 20. The spool 32 is rotatably placed on the hub 20. By using the spool 32 to store, pull and retract the ear bud cable 26 reduces the wrapping and tangling of the ear bud cable 26 and also reduces any tendency for the ear bud cable 26 to be damaged through improper storage. Thereby an efficient cord management system for the ear bud cable 26 can be achieved. The power spring 24 is used as a tension mechanism for retracting the ear bud cable 26. Also referring to FIG. 1, at least one among the plurality of side walls 16 of the housing 12 includes an opening 18 (FIG. 2) through which the ear bud cable 26 may be deployed. At least one of the plurality of side walls 16 includes the release button 50 for the ratchet mechanism 48 to retain the length of the ear bud cable 26.

A plurality of gear teeth 38 of the bottom plate 36 of the spool 32 rotatably engages with the plurality of gear teeth 42 of the rotary damper 40. The rotary damper 40 opposes the free rotation tendency of the spool, which is created by the torque produced by the power spring 24. The torque would be uniform in magnitude. The rotary damper 40 regulates the speed of rotation of the spool 32 thereby reducing the speed of retraction of the ear bud cable 26. In this way, the rotary damper 40 limits the maximum angular velocity of the spool 32. Reduction in the angular velocity of the spool 32 protects the cartridge 10 from damage. Also the plurality of gear teeth 42 of the rotary damper 40 presses against the plurality of gear teeth 38 of the bottom plate 36 of the spool 32. This force prevents the misalignment of the spool 32 thereby increasing the life and reliability of the cartridge 10.

The ratchet mechanism is employed to retain a particular position of the spool 32 after extending ear bud cable 26. The ratchet mechanism prevents the rotation of the spool 32 to retract the ear bud cable 26. When the release button 50 provided on at least one of the plurality of side walls 16 is pressed, the compression spring (not shown) associated with the ratchet mechanism pushes the ratchet arm 48 to engage with any of the plurality of gear teeth 38 provided on the periphery of the bottom plate 36 of the spool 32. This will block the free rotation of the spool 32 and keeps a portion of the ear bud cable 26, which is deployed at any desired length, outside the housing 12.

FIG. 2 is a perspective view of the bottom portion 14 of the cartridge 10 with the spool 32 shown in an exploded form. A cable track is formed in between the top plate 34 and the bottom plate 36 of the spool 32. The ear bud cable 26 is wound in the cable track. The top plate 34 and the bottom plate 36 of the spool 32 have substantially a circular shape. The bottom plate of the spool 32 is provided with a plurality of gear teeth 38, cut along the periphery of the bottom plate 36. The power spring 24 has a spiral shape and is designed to maintain a relatively constant torque on the spool 32 while dispensing and retracting the ear bud cable 26.

The first end 28 of the ear bud cable 26 is attached with at least one ear piece and the second end 30 of the ear bud cable 26 is electrically connected to the plurality of stationary audio contacts 22. Preferably, the first end 28 of the ear bud cable 26 also includes a microphone for use with telephonic applications. The ear bud cable 26 is substantially flat and has a height and a width. But the width of the ear bud cable 26 is more than the height. The flat shape of the ear bud cable 26 consumes only less space than round shaped ear bud cables. The flat shaped ear bud cable 26 has a minimum thickness to increase the length of the cable that can be wrapped around the spool 32. Also the flat shape of the ear bud cable 26 reduces any risk that the ear bud cable 26 will bind in the cartridge 10.

An improved tangential pressure is achieved between the spool 32 and the rotary damper 40 by using a plurality gear teeth engaged with each other. The element of radial force existing between the rotary damper 40 and the spool 32 prevents any misalignment that may happen to the spool 32 in operation. The electrical connection from the portable electronic device is provided to the ear bud cable 26 by utilizing the plurality of stationary audio contacts 22 fixed on the bottom portion 14. The portable electronic device may also include mobile audio devices such as an I-phone, I-pad, or similar devices.

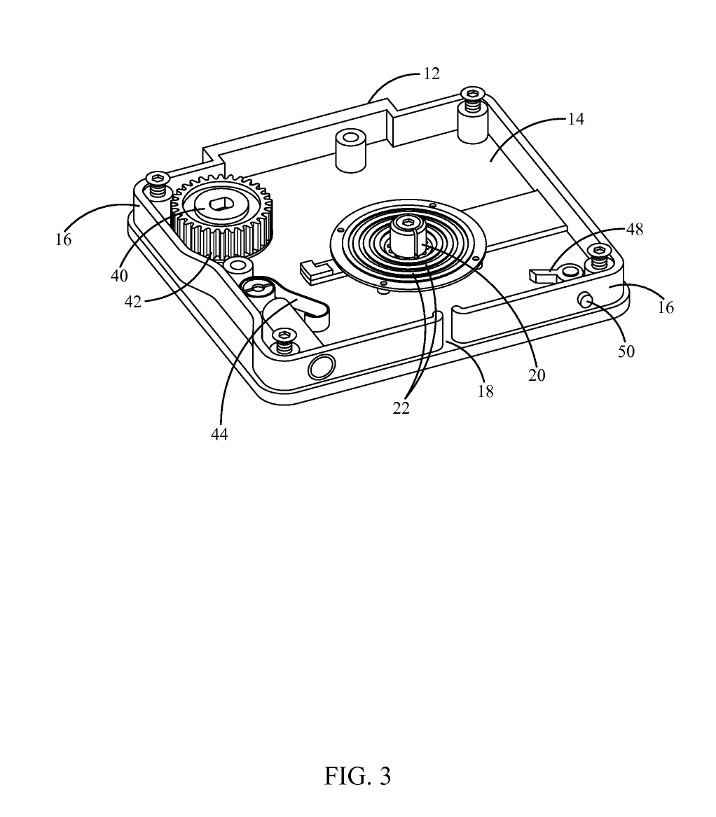

FIG. 3 is a perspective view of the bottom portion 14 of the cartridge 10 with the spool 32 removed from the hub 20. The plurality of stationary audio contacts 22 forms four annular rings around the hub 20. The four annular rings are electrically connected to a left speaker, right speaker, ground and a microphone. Each of the plurality of stationary audio contacts 22 are co-planar and maintain a fixed radial distance from the hub 20. Also each of the plurality of the plurality of stationary audio contacts 22 is insulated from each other and from the housing 12 by providing an insulating material between them.

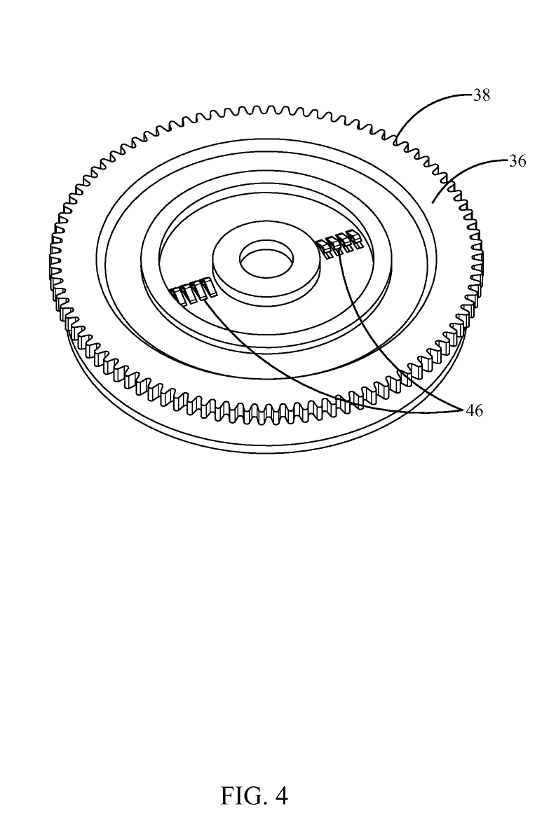

FIG. 4 is a perspective view of a bottom portion of the spool 32. The spool 32 includes a plurality of conductive contacts 46 on a bottom side of the spool 32. The plurality of conductive contacts 46 maintains continuous contact with the plurality of stationary audio contacts 22. The plurality of conductive contacts 46 may be metallic contacts or made from any suitable electrically conductive material. The plurality of conductive contacts 46 are fixed at specific distances on the bottom of the spool 32. The plurality of conductive contacts 46 may be provided with springs which ensure continuous contact to the plurality of stationary audio contacts 22.

As the spool 32 rotates the plurality of conductive contacts 46 slides over the plurality of stationary audio contacts 22 thereby completing electrical connection from the audio device to the ear bud cable 26. An auxiliary audio jack may be provided on any of the plurality of side walls 16 of the housing 12. An audio signal connection can be provided between the plurality of stationary audio contacts 22 and an external audio device through the auxiliary audio jack. The microphone attached to the first end 28 of the ear bud cable 26 enables the auxiliary audio jack (not shown) to simultaneously function as an output jack.

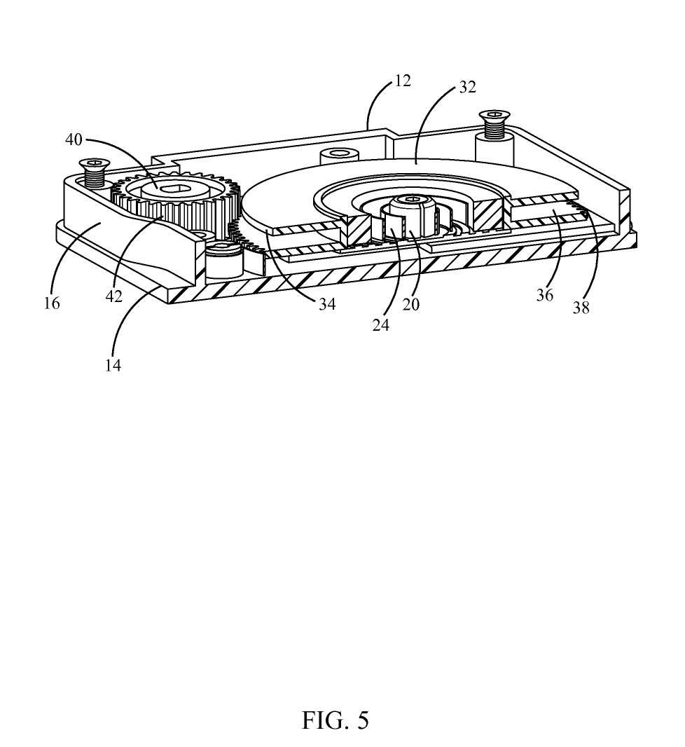

FIG. 5 is a cross-sectional view of the cartridge 10 with the top plate (not shown) removed from the housing 12. The top plate 34 and the bottom plate 36 of the spool are arranged so as to maintain the height of the cable track sufficient enough to wind the ear bud cable 26. The ear bud cable 26 wound on the cable track between the top plate 34 and the bottom plate 36 of the spool 32. The cable guide 44 directs the ear bud cable 26 into the cable track while dispensing and extracting. The cable guide 44 also prevents tangling of the ear bud cable 26. The housing 12 may also include a contact pad for enabling communication with the portable electronic device.

The foregoing description of the preferred embodiment of the present invention has been presented for the purpose of illustration and description. It is not intended to be exhaustive or to limit the invention to the precise form disclosed. Many modifications and variations are possible in light of the above teachings. For example, the power spring 24 may be mounted within the rotary damper 40 to retract the ear bud cable 26. Also the cartridge 10 may further include various audio connectors on any of the plurality of side walls 16, for connecting an external headset. It is intended that the scope of the present invention not be limited by this detailed description, but by the claims and the equivalents to the claims appended hereto.

We claim:

1. A cartridge connectable with a portable electronic device for managing an ear bud cable, the cartridge comprising:
a housing having a top portion, a bottom portion and a plurality of side walls;
a hub fixed on the bottom portion of the housing;
a plurality of stationary audio contacts placed around the hub;
a spool having a top plate and a bottom plate rotatably mounted on the hub;
a plurality of conductive contacts on the bottom plate for communicating audio signals with the stationary audio contacts;
a power spring in operative contact with the spool for rotating the spool; and
an ear bud cable having a first end, and a second end wrapped at least partially around the spool,
whereby rotation of the spool dispenses and retracts the ear bud cable while maintaining continuous electrical contact between the conductive contacts of the bottom plate and the stationary audio contacts.

2. The cartridge as set forth in claim 1, wherein the plurality of side walls includes at least one opening through which the ear bud cable extends.

3. The cartridge as set forth in claim 1, wherein the hub has a substantially cylindrical shape.

4. The cartridge as set forth in claim 1, wherein the plurality of stationary audio contacts forms a plurality of annular rings around the hub.

5. The cartridge as set forth in claim 1, wherein the plurality of stationary audio contacts is insulated from the housing and is insulated from each other.

6. The cartridge as set forth in claim 1, wherein the power spring has a spiral shape.

7. The cartridge as set forth in claim 1, wherein the power spring rotates the spool to retract the ear bud cable.

8. The cartridge as set forth in claim 1, wherein the top plate and the bottom plate of the spool has a substantially circular shape and define a cable track between the top plate and the bottom plate.

9. The cartridge as set forth in claim 1, wherein the plurality of conductive contacts provides electrical connection between the ear bud cable and the portable electronic device.

10. The cartridge as set forth in claim 8, wherein the ear bud cable is flat and wound around the cable track between the circular top plate and the bottom plate of the spool.

11. The cartridge as set forth in claim 1, wherein the first end of the ear bud cable is electrically connected to the portable electronic device through the a plurality of stationary audio contacts and the plurality of conductive contacts provided on the spool.

12. The cartridge as set forth in claim 1, wherein the housing includes an auxiliary audio jack provided on the at least one of the plurality of side walls.

13. The cartridge as set forth in claim 12, wherein the auxiliary audio jack is electronically connectable to an audio source.

14. The cartridge as set forth in claim 12, wherein the housing includes a contact pad for enabling the cartridge to connect, in electronic communication, with the portable electronic device.

15. A cartridge connectable with a portable electronic device for managing an ear bud cable, the cartridge comprising:
a housing;
a hub fixed on the housing;
a plurality of stationary audio contacts placed in an annular pattern around the hub;
a spool having a top plate and a bottom plate rotatably mounted on the hub;
a plurality of conductive contacts on the bottom plate for establishing continuous electrical contact with the stationary audio contacts; and
an ear bud cable having a first end, and a second end wrapped at least partially around the spool, the ear bud cable being in electrical communication with the conductive contacts,
whereby rotation of the spool dispenses and retracts the ear bud cable while maintaining continuous electrical contact between the conductive contacts of the bottom plate and the stationary audio contacts.

16. A cartridge as set forth in claim 15, wherein the conductive contacts are spring loaded.

17. A cartridge as set forth in claim 16, wherein the stationary audio contacts are evenly spaced.

18. A cartridge as set forth in claim 16, wherein the housing includes a contact pad for enabling the cartridge to connect, in electronic communication, with the portable electronic device, the stationary audio contacts electrically connect with the contact pad.

19. A cartridge as set forth in claim 17, wherein the housing includes an auxiliary audio jack and the stationary audio contacts electrically connect with the stationary audio jack.

20. A cartridge as set forth in claim 18, wherein the second end of the ear bud cable electrically connects with the conductive contacts of the spool.
